(19) United States
(12) Patent Application Publication
(10) Pub. No.: US 2001/0040557 A1
(43) Pub. Date: Nov. 15, 2001

(54) Wrist rest having a two-handed scrolling mode switch

(76) Inventor: Edwin Joseph Selker, Palo Alto, CA (US)

Correspondence Address: ROBERT BUCKLEY, PATENT ATTORNEY, P.O. BOX 2520, MENLO PARK, CA, 94026-2520, US

(21) Appl. No.: 09/538,315

(22) Filed: Mar. 30, 2000

Related U.S. Application Data
(62) Division of application No. 09/083,774, filed on May 22, 1998.

(51) Int. Cl. G09G 5/00

(52) U.S. Cl. 345/168

(57) ABSTRACT

A computer input device includes a keyboard, a pair of pointing devices, control buttons and an additional thumb operable control button for selecting the operating mode of one or both pointing devices. In an alternative embodiment, a computer input device includes a wrist rest having a pair of pointing devices, control buttons and an additional thumb operable control button for selecting the operating mode of one or both pointing devices. In another embodiment, the keyboard shift keys are used to select the operating mode of one or both pointing devices.

### RELATED APPLICATION

This Application is related to the following co-pending U.S. patent applications, all filed on the same date and assigned to the International Business Machines Corporation: “Keyboard/Wrist Rest Having Third Button for Multimode Operation,” docket number AM9-97-178; “Keyboard Having Buttons Positioned for Operation by Heel of Hand,” docket number AM9-97-179: “Wrist Rest Having Buttons Positioned for Thumbs While Typing,” docket number AM9-97-181.

### FIELD OF THE INVENTION

The invention generally relates to information processing systems, and more specifically, to keyboard-related control buttons used with graphical user interfaces to information processing systems. The invention has a particular applicability to IBM® keyboards, computers, and the IBM ThinkPad® notebook computer. (IBM and ThinkPad are registered trademarks of the International Business Machines Corporation.)

### BACKGROUND OF THE INVENTION

Many persons are familiar with computer systems which provide a graphical user interface (“GUI”), a pointing device and a keyboard for controlling the computer. Many are also familiar with game playing computer programs which permit a user to use a joystick or hand-operated control unit for interacting with the characters and events of the game. Recently computer applications have appeared which require navigation in a simulated three-dimensional space. In fact, some computers including specific models of the IBM ThinkPad notebook computer, are available with a pair of pointing devices built into the keyboard to make navigation in a displayed three-dimensional space a more natural and easy to use possibility (see for example the co-pending U.S. patent application entitled “Input for Three Dimensional Navigation Using Two Joysticks,” Ser. No. 08/979,712, filed Nov. 30, 1997, assigned to the International Business Machines Corporation).

It is desirable to select an operating mode for the pointing devices in computers having more than one pointing device. At present this mode switching is accomplished using the graphical user interface and “settings” windows and dialog boxes. Though these methods work well and will continue to be used, there are situations in which a more natural mode switching could be accomplished to the benefit of the computer user. For example, it is desirable to switch the purpose of one of two pointing devices from displayed-pointer positioning to page and document scrolling. When this mode change can be made rapidly and without too much thought, certain types of GUI interactions become more efficient and less taxing on the user.

What is needed is a simple way to switch the operating mode of one or both pointing devices in multi-pointing device computer systems.

### SUMMARY OF THE INVENTION

This need, and others that will become apparent, is met by the present invention which provides a mode selection switch located for operation by the thumbs of either hand. In another embodiment, the invention uses the two shift keys found on most keyboards for controlling the operating mode of two pointing devices.

### BRIEF DESCRIPTION OF THE DRAWINGS

For a further understanding of the objects, features and advantages of the present invention, reference should be had to the following description of the preferred embodiment, taken in conjunction with the accompanying drawing, in which like parts are given like reference numerals and wherein:

FIG. 1 is a partial plan view illustrating a keyboard computer input device having staggered pointing devices and a mode selection control button.

FIG. 2 is a partial plan view illustrating a keyboard computer input device having tandem pointing devices and a mode selection control button.

FIG. 3 is a partial plan view illustrating a wrist rest computer input device having a pair of pointing devices and control buttons including a mode selection control button.

FIG. 4 is a partial plan view illustrating a wrist rest computer input device having a pair of pointing devices, control buttons, and using the shift keys of a keyboard for mode selection control buttons for the pointing devices.

FIG. 5 is a block diagram illustrating a software driver which monitors the two shift keys of FIG. 4 and provides a mode select command to an operating system when a shift key is depressed.

FIG. 6 is a partial block diagram illustrating an electronic circuit which monitors the two shift keys of FIG. 4 and provides a mode select signal to a computer when a shift key is depressed.

FIG. 7 is a schematic plan view illustrating a stand-alone keyboard input device having a pair of pointing devices, control buttons, a mode selection control button, and a cable and connector for making electrical connection to a computer.

FIG. 8 is a partial plan view illustrating a computer keyboard having a pair of pointing devices and using two shift keys as mode selection control buttons.

### DESCRIPTION OF THE PREFERRED EMBODIMENT

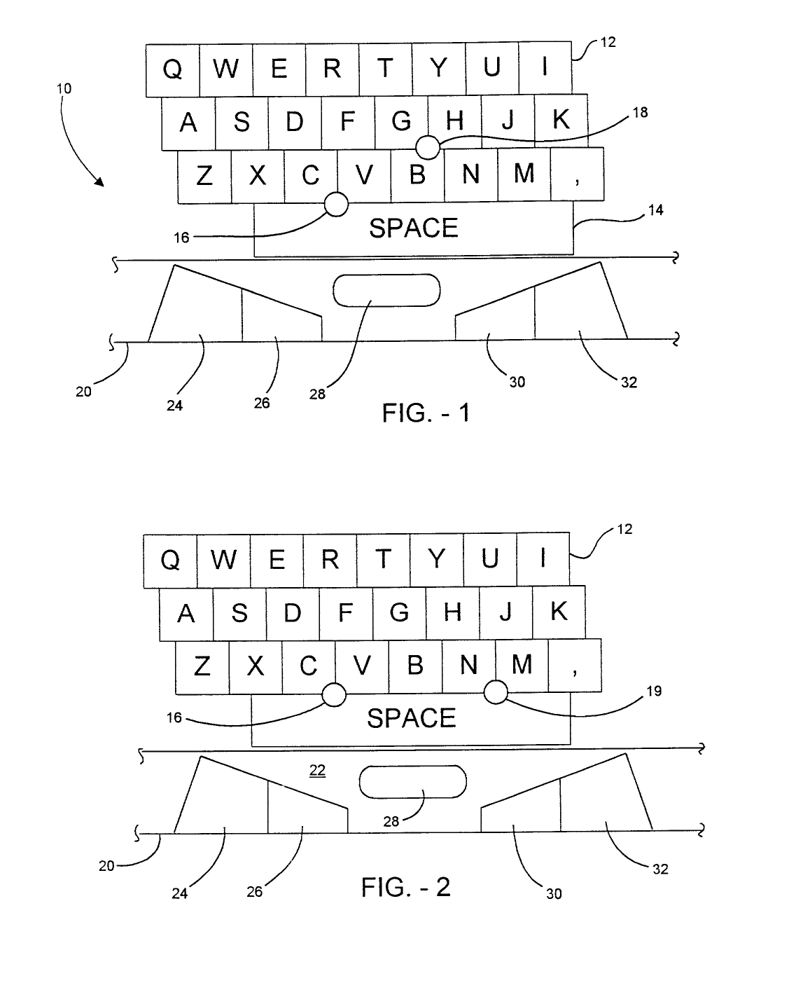

With reference to FIG. 1 there is shown a partial plan view of a computer keyboard input device, designated generally by the reference numeral 10, including a two-handed scrolling mode switch according to one aspect of the present invention.

The input device 10 includes a keyboard defining a field of keys 12 including a space bar 14, a pair of isometric pointing devices 16, 18 located within the field of keys for finger-tip operation, a keyboard edge region 20 including a portion 22 adjacent the space bar, a plurality of operational buttons 24-32 located within the keyboard edge region portion 22, the button 28 defining a switch for selecting an operating mode for at least one isometric pointing device 16, 18, and electrical circuits (not shown) for connecting the keyboard, the pointing devices and the operational buttons to a computer or other electronic assembly.

In a specific embodiment, the isometric pointing devices 16, 18 are located in staggered positions, the device 16 being located at the bottom mid-point between the ‘C’ and the ‘V’ keys, while the pointing device 18 is located at the bottom mid-point between the ‘G’ and the ‘H’ keys.

FIG. 2 is a partial plan view of a computer keyboard input device similar to the input device of FIG. 1, except that a pointing device 19 is located at the bottom mid-point between the ‘N’ and the ‘M’ keys, side-by-side with the pointing device 16.

In another specific embodiment, the operational buttons 24, 26 define left- and right-mouse buttons, respectively, for the pointing device 16, while the operational buttons 30, 32 define left- and right- mouse buttons, respectively, for the pointing device 18 of FIG. 1, and 19 of FIG. 2.

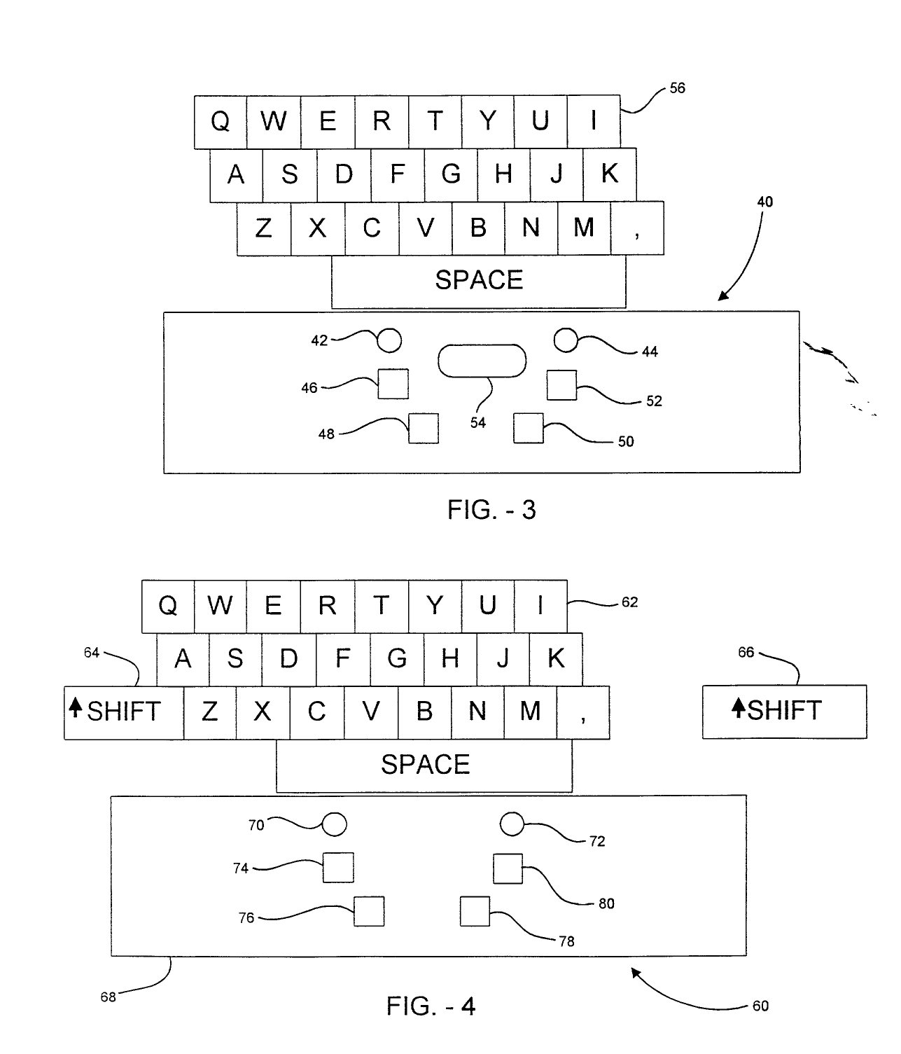

FIG. 3 is a partial plan view of a computer input device, designated generally by the reference numeral 40, defining a wrist rest having operational buttons, two pointing devices, and a two-handed scrolling mode switch according to another aspect of the present invention. The input device 40 includes a pair of isometric pointing devices 42, 44, operational buttons 46-52, a mode selection switch 54, and circuits (not shown) for electrically connecting the pointing devices, the operational buttons, and the mode selection switch to a computer or other electronic assembly. A keyboard 56 is shown for reference only, and does not form part of the specific embodiment illustrated in FIG. 3.

FIG. 4 is a partial plan view of a computer keyboard input system having a pair of isometric pointing devices located in a wrist rest and using keyboard shift keys as mode selection switches. The input system is designated generally by the reference numeral 60 and includes a keyboard 62 (a portion of which is shown) having a pair of shift keys 64, 66, a wrist rest 68 including a pair of isometric pointing devices 70, 72, and operational buttons 74-80.

FIG. 5 is a schematic diagram which illustrates a specific embodiment of the input system 60 which includes a software driver 90 responsive to a shift key 92, 94 for selecting an alternative operating mode for a related isometric pointing device (not shown). In a specific embodiment, the software driver 90 is part of an operating system environment of a computer or other electronic assembly. The software driver 90 monitors keyboard activity 96, 98 and responds to the depressing of either shift key 92, 94 for generating a mode select command 100.

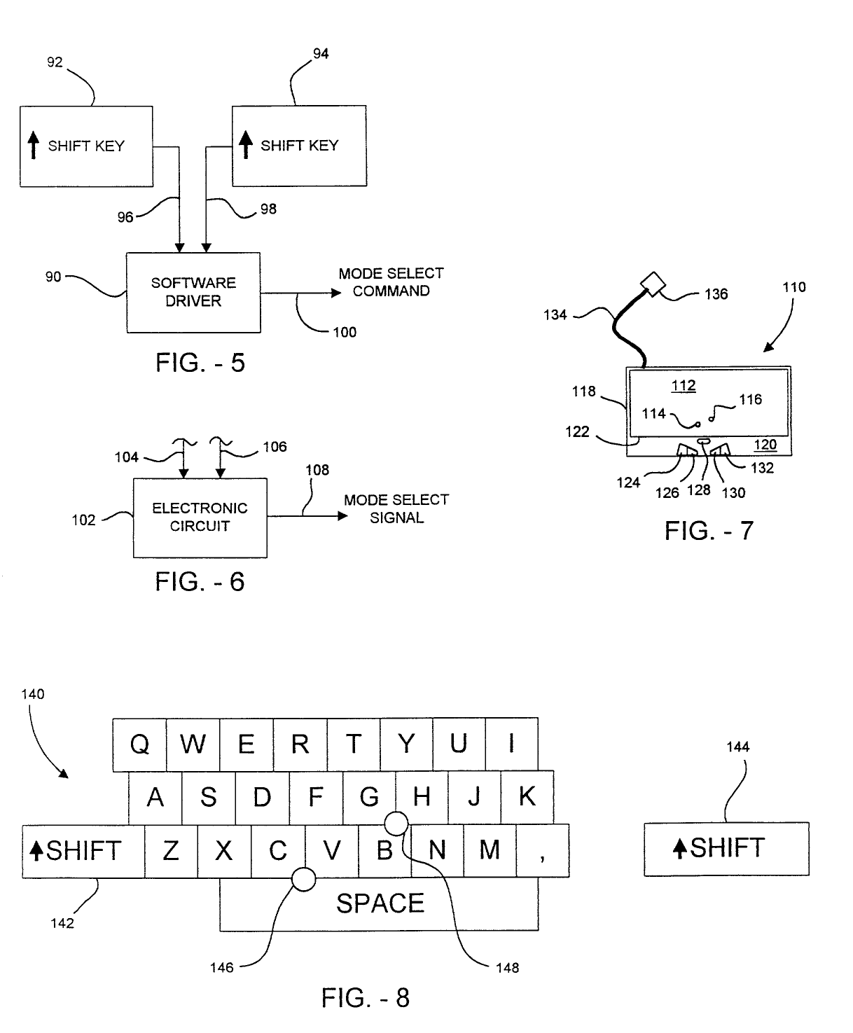

FIG. 6 is a partial schematic diagram which illustrates another specific embodiment of the input system 60 which includes an electronic circuit 102 responsive to a shift key 92, 94 (FIG. 5) for selecting an alternative operating mode for a related pointing device (not shown). In a specific embodiment of the input system 60, the circuit 102 is located within a keyboard operational button, pointing device cluster and monitors keyboard activity 104, 106 to generate a mode select signal 108 when a shift key is depressed.

In a specific embodiment, the input system 60 includes electrical components for connecting the keyboard, the shift keys, and the pointing devices to a computer or other electronic assembly. FIG. 7 is a plan view of a keyboard input system, designated generally by the reference numeral 110, and includes a keyboard 112, pointing devices 114, 116, the keyboard having a surrounding edge region 118 having a portion 120 along a front edge of the keyboard. The edge region portion 120 includes operational buttons 124-132, as previously described with respect to FIG. 1. The input system 110 also includes a cable 134 having an electrical connector 136 for connecting the system to a computer or other electronic assembly.

In an alternative embodiment of the keyboard input system (not shown), the keyboard 112, pointing devices 114, 116, and the operational buttons 124-132, are incorporated into a notebook computer. In a specific embodiment, the edge region portion 120 defines a wrist rest for the notebook computer.

Finally, FIG. 8 is a partial plan view which illustrates another keyboard input system, designated generally by the reference numeral 140, in which shift keys 142, 144 provide mode selection buttons for selecting an operating mode for one or more pointing devices 146, 148.

While the invention has been described in relation to the embodiments shown in the accompanying Drawing figures, other embodiments, alternatives and modifications will be apparent to those skilled in the art. It is intended that the Specification be exemplary only, and that the true scope and spirit of the invention be indicated by the following claims.

What is claimed is:

1. A computer input device, comprising:
a keyboard defining a field of keys including a space bar;
a pair of isometric pointing devices located within the field of keys for finger-tip operation;
a keyboard edge region including a portion adjacent the space bar;
a plurality of operational buttons located within the keyboard edge region portion;
one of said operational buttons defining a switch for selecting an operating mode for at least one isometric pointing device; and
means for electrically connecting the keyboard, the pointing devices, and the operational buttons to an electronic assembly.

2. The input device as set forth in claim 1, wherein the two pointing devices are placed in staggered positions, one pointing device being located a first distance from the space bar, and the other pointing device being located a second distance from the space bar.

3. The input device as set forth in claim 1, wherein both pointing devices are placed at the same distance from the space bar.

4. The input device as set forth in claim 1, wherein the operating buttons define a left pair for a left pointing device, a right pair for a right pointing device, and a mode selection switch.

5. A computer input device, comprising:
a wrist rest;
a pair of isometric pointing devices disposed in the wrist rest for finger-tip operation by opposing hands;
a plurality of operational buttons disposed on the wrist rest;
one of said operational buttons being located on the wrist rest for convenient access by either hand;
said one operational button defining a switch for selecting an operating mode for at least one of said pointing devices; and
means for electrically connecting the pointing devices and the operational buttons to an electronic assembly.

6. The input device as set forth in claim 5, wherein the device is a stand-alone item for use with a computer keyboard.

7. The input device as set forth in claim 5, wherein the device is part of a notebook computer.

8. A computer keyboard input system, comprising:
a keyboard including at least one shift key;
a wrist rest;
a pair of isometric pointing devices located on the wrist rest for finger-tip operation;
a plurality of operational buttons located on the wrist rest;
means responsive to the at least one shift key for selecting an alternative operating mode for one isometric pointing device; and
means for electrically connecting the keyboard, the at least one shift key, the pointing devices, and the means responsive to the at least one shift key to an electronic assembly.

9. The input system as set forth in claim 8, further including two shift keys, one of the shift keys selecting the operating mode for each of the two pointing devices.

10. The input system as set forth in claim 8, further including the means responsive to a shift key defining a method such that when the shift key is depressed, the corresponding pointing device operates in an alternative mode.

11. The input system as set forth in claim 10, wherein the alternative mode is a scrolling mode.

12. The input system as set forth in claim 10, wherein the alternative mode is a magnifying glass positioning mode.

13. The input system as set forth in claim 9, wherein a left shift key selects an operating mode for the left pointing device, and a right shift key selects an operating mode for the right pointing device.

14. A computer keyboard input system, comprising:
a keyboard including at least one shift key and defining a field of keys;
a pair of isometric pointing devices located within the field of keys for finger-tip operation;
means responsive to the at least one shift key for selecting an alternative operating mode for one isometric pointing device; and
means for electrically connecting the keyboard, the at least one shift key, the pointing devices, and the means responsive to the at least one shift key to an electronic assembly.

15. The input system as set forth in claim 14, wherein a left shift key selects an operating mode for a left pointing device, and a right shift key selects an operating mode for a right pointing device.

16. The input device as set forth in claim 14, wherein each pointing device is located at a different distance above the space bar, providing a staggered placement of pointing devices.

17. The input device as set forth in claim 14, wherein each pointing device is located an equal distance above the space bar, providing a side-by-side placement of pointing devices.
